(19) United States
(12) Patent Application Publication
(10) Pub. No.: US 2011/0174435 A1
(43) Pub. Date: Jul. 21, 2011

(54) Microwell Sampling Tape Sealing Apparatus and Methods

(76) Inventor: Bruce Malcolm Peterson, Alexandria, MN (US)

(21) Appl. No.: 13/121,439

(22) PCT Filed: Oct. 1, 2009
(86) PCT No.: PCT/US2009/059180

§ 371 Date: Mar. 29, 2011

Related U.S. Application Data
(60) Provisional application No. 61/102,193, filed on Oct. 2, 2008.

(51) Int. Cl. B29C 65/78; B29C 65/00

(52) U.S. Cl. 156/292; 156/423

(57) ABSTRACT

A sealing station (10) includes a shell (100) having holes (106) extending between inner and outer peripheries (102, 104) and arranged in a pattern to receive wells (30) of a carrier tape (20) directed on a portion of the outer periphery (104). Spaced, raised surfaces (150) are formed on the outer periphery (104) concentrically around and corresponding to the plurality of holes (106). A press roller (130) sandwiches a seal tape (60) against the carrier tape (20) in turn sandwiched against the spaced, raised surfaces (150) of the outer periphery (104) of the shell (100) to bond the seal tape (60) to the carrier tape (20) at areas corresponding to the spaced, raised surfaces (150).

### BACKGROUND

The present invention generally relates to apparatus and methods for sealing microwell sampling tape with a sealing tape.

A conventional station for sealing microwell sampling tape utilizes a solid drum with cavities which register with the wells of the microwell sampling tape. The solid drum is used as support for the application of a seal tape. The seal tape can be adhesive or thermal bonded. Conventionally, the seal tape is bonded to the entire area of the sampling tape around the wells, which makes removal of the seal tape difficult if and when desired. Additionally, the samples being sealed in the wells are, in most cases, thermally sensitive. However, due to its solid nature, solid drums can maintain temperature differentials which can be transferred to the samples. Likewise, the sampling tape around the wells seals with the solid drum around the cavities to prevent air communication to the cavities. Furthermore, the size and shapes of the wells utilized in microwell sampling tapes vary significantly. Cavities in conventional solid drums were custom sized according to the particular size and shapes of wells of the desired microwell sampling tape. Thus, multiple solid drums were required to seal microwell sampling tape with wells of differing shapes and sizes.

Thus, a need exists for methods and apparatus for sealing microwell sample tape which overcome the deficiencies of the prior art.

### SUMMARY

The present invention solves this need and other problems in the field of sealing microwell sampling tape, in preferred aspects, by sandwiching a seal tape and a carrier tape directed over a portion of an outer periphery of a shell having annular cross sections and having holes extending through the shell between the inner and outer peripheries and receiving the wells. In preferred aspects, the shell has circular cross sections and is cantilever supported by a shaft extending along an axial center from an inner end of the shell. In further preferred aspects, air is introduced through the open outer end of the shell.

In other aspects of the present invention, a sealing tape is sandwiched against a carrier tape directed over a plurality of spaced, raised surfaces on the outer periphery around and corresponding to holes receiving wells of the carrier tape to thereby bond the seal tape substantially exclusively corresponding to the plurality of spaced, raised surfaces. In further preferred aspects, the spaced, raised surfaces are in the pattern of the holes of the shell and/or the wells of the carrier tape.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of an apparatus module including a sealing station according to the preferred teachings of the present invention.

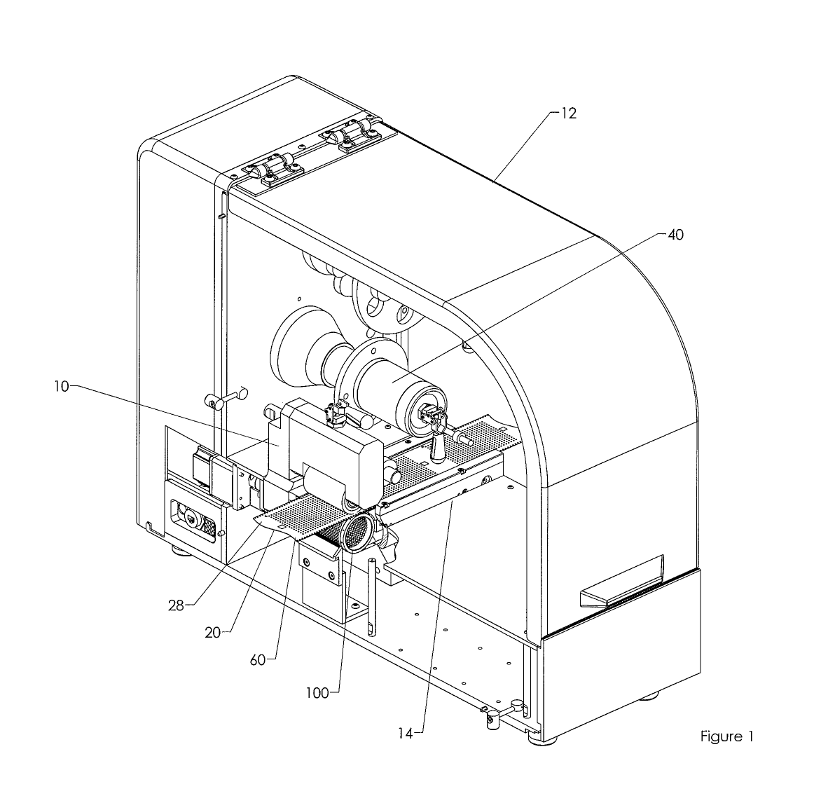

FIG. 2 shows an enlarged perspective view of the apparatus of the sealing station of the apparatus module of FIG. 1.

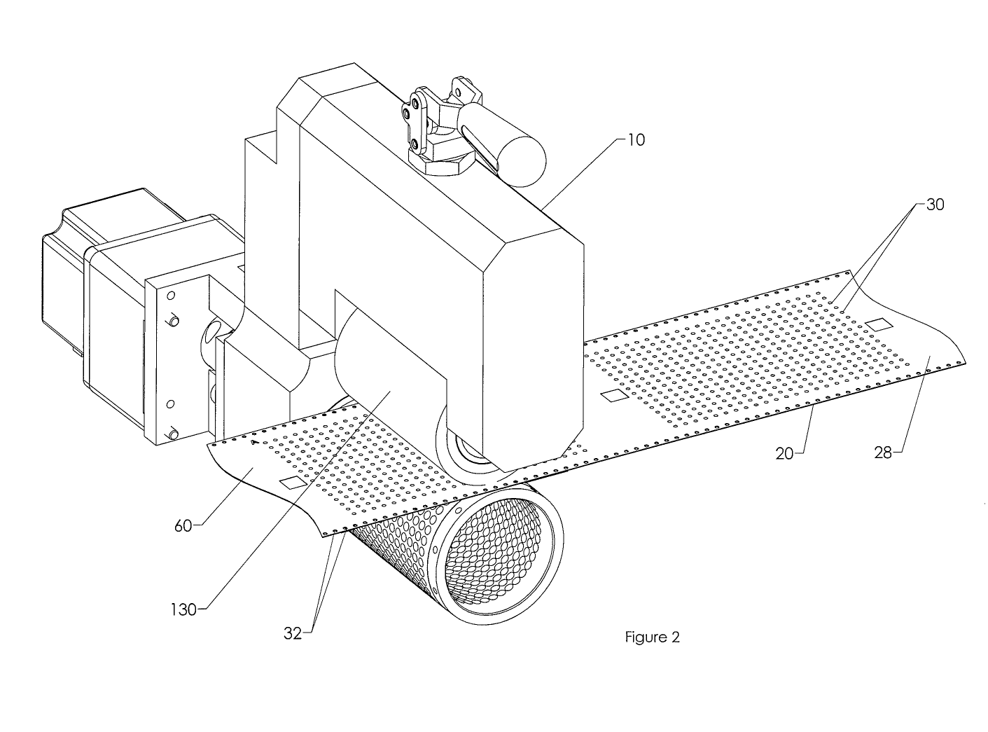

FIG. 3 shows a diagrammatic side view illustrating operation of the sealing station of FIG. 2, with portions broken away to show internal construction.

FIG. 4 shows a shell of an alternate embodiment of a sealing station according to the preferred teachings of the present invention, with portions broken away to show internal construction.

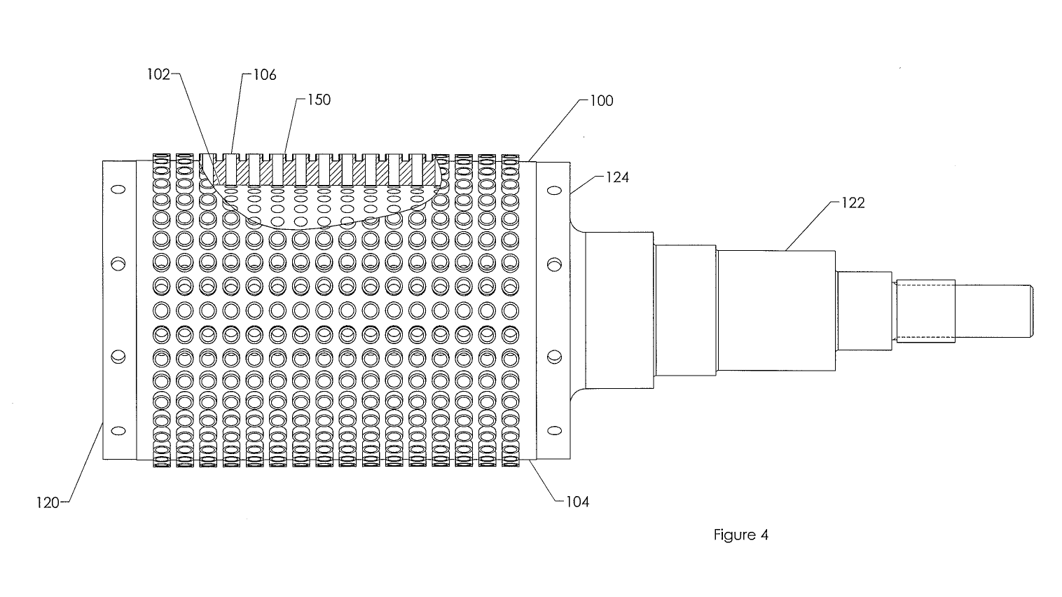

All figures are drawn for ease of explanation of the basic teachings of the present invention only; the extensions of the figures with respect to number, position, relationship, and dimensions of the parts to form the preferred embodiments will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “top”, “bottom”, “first”, “second”, “forward”, “rearward”, “reverse”, “front”, “back”, “height”, “width”, “length”, “end”, “side”, “horizontal”, “vertical”, and similar terms are used herein, it should be understood that these terms have reference only to the structure shown in the drawings as it would appear to a person viewing the drawings and are utilized only to facilitate describing the illustrative embodiments.

### DESCRIPTION OF THE PREFERRED EMBODIMENTS

A sealing station according to the preferred teachings of the present invention is shown in the drawings and generally designated 10. In the preferred form shown, sealing station 10 is included in a module 12 which can be a part of a microwell sampling tape screening apparatus. In particular, module 12 can include a portion 14 for feeding and/or directing a microwell sample carrier tape 20. Microwell sample carrier tape 20 can be of any type or form including but not limited to that shown in U.S. Pat. No. 6,878,345, which is hereby incorporated herein by reference. Carrier tape 20 includes a substrate 28 having a plurality of wells 30 embossed therein in specific patterns, such as, but not limited to, arrays including columns and rows. Wells 30 are adapted to hold samples such as liquid therein. A plurality of sprocket drive holes 32 is provided along each edge to permit tractor driving, if desired. In this respect, sprocket drive holes 32 have a positional relationship to wells 30. Wells 30 can have a variety of shapes and/or sizes depending upon the function of the screening apparatus in which module 12 having sealing station 10 is included.

Module 12 can also include suitable provisions 40 for providing a seal tape 60. Seal tape 60 is suitably bonded to carrier tape 20 such as, but not limited to, by being adhered or thermally bonded thereto. Seal tape 60 can be formed of any suitable material which has sufficient characteristics to be sealed to and unsealed from carrier tape 20 and to seal the samples within wells 30.

Sealing station 10 according to the preferred teachings of the present invention includes a shell 100 having an outer periphery 104 movable along a continuous path. In a preferred form of the present invention, shell 100 has annular cross sections with an inner periphery 102 located within and spaced from outer periphery 104. In preferred forms, inner periphery 102 has equal spacing from outer periphery 104 along the entire continuous path. Specifically, in the preferred form shown, inner and outer peripheries 102 and 104 have concentric, circular cross sections.

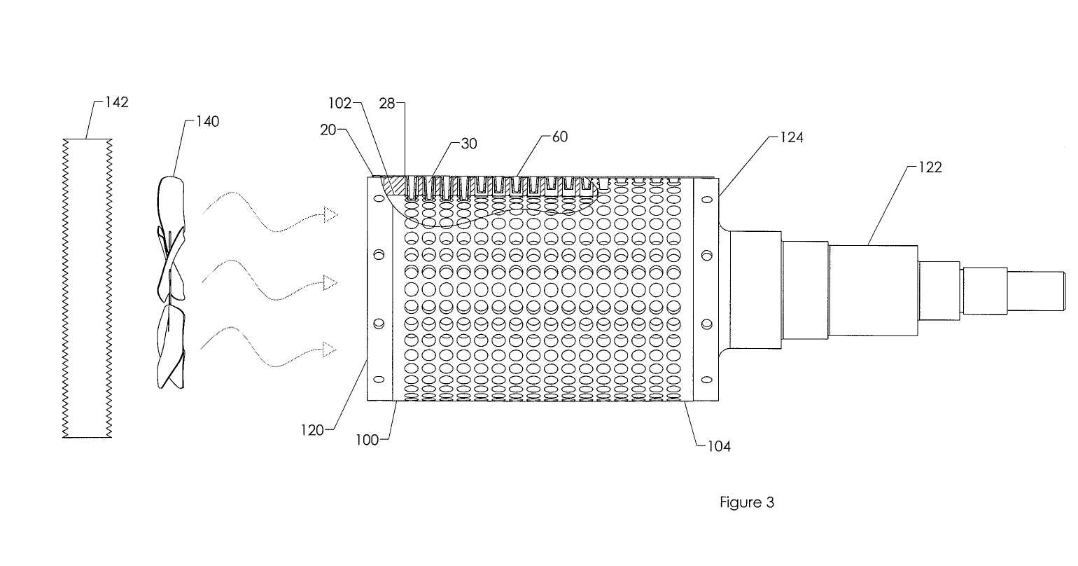

In the preferred form shown, a plurality of holes 106 extend through the shell 100 between peripheries 102 and 104 and in a pattern corresponding to and for receiving individual wells 30. In the most preferred form, holes 106 are provided of a shape and size for receiving wells 30 of a range of sizes and shapes which are capable of being screened in the screening apparatus in which module 12 is utilized. As diagrammatically shown in FIG. 3, wells 30 of four different sizes (but all including flat bottoms and frusto-conical sidewalls) are received in holes 106 of shell 100 (with it being understood that wells 30 of a same size and shape being typically provided in carrier tape 20 and that FIG. 3 is being provided for illustration only to show a range of sizes of wells 30 which could be received in holes 106). In the most preferred form, holes 106 are of circular cross sections of a constant size between peripheries 102 and 104.

In the most preferred form shown, shell 100 is cantilevered supported such that an outer end 120 is open and not obstructed by the frame or other portion of module 12 and/or sealing station 10. A shaft 122 extending along the axial center of the concentric, circular cross sections of peripheries 102 and 104 and from a hub received and suitably connected in the inner periphery 102 of an inner end 124 of shell 100, with ends 120 and 124 being opposite to each other. Inner and outer peripheries 102 and 104 extend between ends 120 and 124.

Sealing station 10 according to the preferred teachings of the present invention further includes suitable provisions such as a press roller 130 shown for sandwiching carrier tape 20 and seal tape 60 against shell 100 which functions as an anvil in sealing station 10. In particular, in the preferred form shown, press roller 130 sandwiches seal tape 60 against substrate 28 of carrier tape 20 which in turn is sandwiched against outer periphery 104 of shell 100 as shell 100 moves relative to press roller 130 such as by rotation of shaft 122. When sandwiched, seal tape 60 bonds to carrier tape 20 such as by being adhesively or cohesively secured, by thermal bonding, or the like. In this regard, shell 100 and/or press roller 130 can include suitable provisions for enhancing bonding of the seal tape 60 to carrier tape 20, if desired.

Suitable provisions can be provided in module 12 for providing ambient, heated, and/or cooled air according to the preferred teachings of the present invention. Such provisions are diagrammatically shown as a fan 140 and a heat transfer element 142 in FIG. 3 for moving air into or out of open outer end 120. Also, the inner periphery 102 can include suitable provisions such as vanes, if desired, to enhance air movement or circulation.

In further aspects of the present invention, a plurality of spaced, raised surfaces 150 can be provided on outer periphery 104 around and corresponding to holes 106. In the most preferred form shown, raised surfaces 150 are in the pattern of holes 106 and spaced from each other. Furthermore, with wells 100 having circular openings, raised surfaces 150 are annular shaped and particularly concentric with the openings of wells 100 and of circular configurations. Thus, the outer periphery 104 of shell 100 includes grooves located intermediate raised surfaces 150 which intersect according to the preferred teachings of the present invention.

Now that the basic teachings of the present invention have been explained, many extensions and variations will be obvious to one having ordinary skill in the art. For example, although module 10 of the most preferred form includes the combination of several, unique features believed to obtain synergistic results, apparatus for sealing microwell sampling tape could be constructed according to the teachings of the present invention including such features singly or in other combinations. As an example, although shown in the preferred form as included on shell 100 having annular cross sections with holes 106 extending therethrough, raised surfaces 150 could be utilized in solid drums with cavities, with shells having different configurations and/or types and where the holes do not extend therethrough, or the like. Particularly, raised surfaces 150 according to the teachings of the present invention would reduce sample heating if seal tape 60 is thermally bonded to carrier tape 20 and allow for easy removal of seal tape 60 for re-entry into wells 30. Current technology heats and bonds the entire area between the wells and prevents removal of the seal tape. According to the preferred teachings of the present invention, a seal tape 60 is substantially exclusively bonded to carrier tape in areas corresponding to raised surfaces 150 and is either not bonded or bonded with less resistance to removal in the areas intermediate raised surfaces 150. Specifically, in the preferred form with raised surfaces 150 being annular around each of wells 30, a seal ring corresponding to raised surface 150 is created around each well 30 making it easy to remove the seal tape 60.

It should be appreciated that due to the provision of holes 106 in shell 100 according to the preferred teachings of the present invention rather than cavities in a solid drum, air is able to pass within inner periphery 102 of shell 100 and is able to access wells 30 inside of holes 106. Thus, any temperature differential of shell 100 is less likely to be transferred to the samples in wells 30 according to the teachings of the present invention. Particularly, ambient air can typically maintain room temperatures for the samples being tested, with or without provision of fan 140 or other air circulation provisions. Likewise, if temperature needs to be heated or cooled, fan 140 with any heating or cooling element 142 can be added according to the teachings of the present invention.

Likewise, due to holes 106 extending between inner and outer peripheries 102 and 104 of the annular cross sections of shell 100 according to the teachings of the present invention, shell 100 can be utilized in connection with carrier tapes 20 having wells 30 of different sizes and shapes, avoiding the disadvantage of custom sized cavities of conventional solid drums.

Furthermore, although the cantilevered support of shell 100 having an open end 120 is believed to produce synergistic results in the preferred form shown, it should be appreciated that shell 100 can be formed of other types and configurations, can be supported in other manners and approaches and/or can include other provisions for allowing communication of air or other fluids within inner periphery 102 thereof according to the teachings of the present invention.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Method of sealing comprising:
moving a shell having annular cross sections and including inner and outer peripheries, with a plurality of holes extending through the shell between the inner and outer peripheries, with the plurality of holes being in a pattern;
directing a carrier tape over a portion of the outer periphery of the moving shell, with the carrier tape including a plurality of wells corresponding to and received in the pattern of the plurality of holes of the shell; and
sandwiching a seal tape against the carrier tape in turn sandwiched against the outer periphery of the moving shell.

2. The method of claim 1 wherein moving the shell comprises moving the shell having a plurality of spaced, raised surfaces on the outer periphery around and corresponding to the plurality of holes, with sandwiching the seal tape comprising sandwiching the carrier tape against the plurality of spaced, raised surfaces, with the method further comprising: bonding the seal tape to the carrier tape exclusively corresponding to the plurality of spaced, raised surfaces.

3. The method of claim 2 wherein moving the shell comprises moving the shell with the plurality of spaced, raised surfaces in the pattern of the holes and spaced from each other.

4. The method of claim 1 further comprising:
moving air into the inner periphery of the moving shell.

5. The method of claim 4 wherein moving the shell comprises moving the shell having inner and outer ends, with the inner and outer peripheries extending between the inner and outer ends, with the outer end being open, with moving air comprising moving air into the outer open end of the moving shell.

6. The method of claim 5 wherein moving the shell comprises moving the shell with the inner and outer peripheries being of concentric circular cross sections.

7. The method of claim 6 wherein moving the shell comprises rotating a shaft extending along an axial center of the concentric circular cross sections and secured to the shell.

8. The method of claim 7 wherein rotating the shaft comprises rotating the shaft connected to the shell at the inner end to cantilever support the shell.

9. The method of claim 1 wherein directing the carrier tape comprises tractor driving a plurality of sprocket drive holes along each edge of the carrier tape.

10. The method of claim 1 wherein sandwiching the seal tape comprises rolling a press roller on the seal tape opposite to the portion of the outer periphery of the moving shell.

11. Apparatus for sealing samples inside wells arranged in patterns in a carrier tape with a seal tape, comprising an anvil including an outer periphery, with a plurality of holes extending in the anvil from the outer periphery, with the plurality of holes being in the pattern of the wells in the carrier tape, a mechanism directing the carrier tape over a portion of the outer periphery of the anvil with the wells of the carrier tape received in the plurality of holes, and a pressing mechanism sandwiching the seal tape against the carrier tape in turn sandwiched against the outer periphery of the anvil; with the anvil being in the form of a shell having annular cross sections and including an inner periphery, with the plurality of holes extending through the shell between the inner and outer peripheries.

12. The apparatus of claim 11 wherein the shell further includes a plurality of spaced, raised surfaces on the outer periphery around and corresponding to the plurality of holes, with the pressing mechanism including a heater thermally bonding the seal tape to the carrier tape exclusively corresponding to the plurality of spaced, raised surfaces.

13. The apparatus of claim 12 wherein the plurality of spaced, raised surfaces are in the pattern of the holes and spaced from each other.

14. The apparatus of claim 11 further comprising, in combination: an air circulator moving air within the inner periphery of the shell.

15. The apparatus of claim 14 wherein the shell has inner and outer ends, with the inner and outer peripheries extending between the inner and outer ends, with the outer end being open, with the air circulator introducing air through the open outer end of the shell.

16. The apparatus of claim 15 wherein the inner and outer peripheries have concentric circular cross sections.

17. The apparatus of claim 16 wherein the shell includes a shaft extending along an axial center of the concentric circular cross sections and secured to the inner periphery of the shell.

18. The apparatus of claim 17 wherein the shaft is connected to the shell at the inner end to cantilever support the shell.

19. The apparatus of claim 11 wherein the pressing mechanism comprises a press roller rolling relative to the outer periphery of the shell.

20. The apparatus of claim 11 wherein the mechanism comprises a tractor driver engaging a plurality of sprocket drive holes along each edge of the carrier tape.

21. Method of sealing comprising:
moving an outer periphery of an anvil, with a plurality of holes extending from the outer periphery and being in a pattern, with the anvil having a plurality of spaced, raised surfaces on the outer periphery around and corresponding to the plurality of holes;
directing a carrier tape over a portion of the outer periphery of the moving anvil, with the carrier tape including a plurality of wells corresponding to and received in the pattern of the plurality of holes of the moving anvil;
sandwiching a seal tape against the carrier tape in turn sandwiched against the plurality of spaced, raised surfaces of the outer periphery of the moving anvil.

22. The method of claim 21 wherein moving the outer periphery comprises moving the outer periphery with the plurality of spaced, raised surfaces in the pattern of the holes and spaced from each other, with the plurality of spaced, raised surfaces being annular and concentric with the wells.

23. The method of claim 21 wherein the anvil is a shell having annular cross sections and an inner periphery spaced inwardly from the outer periphery, with the inner and outer peripheries being equally spaced, with the inner and outer peripheries being circular, with the holes extending between the inner and outer peripheries.

24. Apparatus for sealing samples inside wells arranged in patterns in a carrier tape with a seal tape, comprising, in combination: an anvil including an outer periphery, with a plurality of holes extending from the outer periphery and in the pattern of the wells in the carrier tape, with the anvil having a plurality of spaced, raised surfaces on the outer periphery around and corresponding to the plurality of holes; a mechanism directing the carrier tape over a portion of the outer periphery of the anvil with the wells of the carrier tape received in the plurality of holes; and a pressing mechanism sandwiching the seal tape against the carrier tape in turn sandwiched against the plurality of spaced, raised surfaces of the outer periphery of the moving anvil.

25. The apparatus of claim 24 wherein the plurality of spaced, raised surfaces in the pattern of the holes is spaced from each other, with the plurality of spaced, raised surfaces being annular and concentric with the wells.

26. The apparatus of claim 24 wherein the anvil is a shell having annular cross sections and an inner periphery spaced inwardly from the outer periphery, with the inner and outer peripheries being equally spaced, with the inner and outer peripheries being circular, with the holes extending between the inner and outer peripheries.
